(19) United States
(12) Patent Application Publication
(10) Pub. No.: US 2017/0033941 A1
(43) Pub. Date: Feb. 2, 2017

(54) MESSAGING SYSTEMS

(71) Applicant: Ignasi Elias De Gispert, Barcelona (ES)

(72) Inventor: Ignasi Elias De Gispert, Barcelona (ES)

(21) Appl. No.: 15/223,076

(22) Filed: Jul. 29, 2016

Related U.S. Application Data
(60) Provisional application No. 62/198,503, filed on Jul. 29, 2015.

(51) Int. Cl. H04L 12/18; H04L 12/58

(52) U.S. Cl. CPC H04L 12/1822; H04L 51/04; H04L 51/32

(57) ABSTRACT

A messaging system is described that is configured to implement, via a suitable computerized device, a method for linking groups of users of a messaging system for a mobile computerized device. The method includes receiving group chat data from a first user, said group chat data including one or more topics, to create an open messaging chat and displaying a list of other users that have joined the open messaging chat to the first user.

### CROSS REFERENCE TO RELATED APPLICATIONS

This application claims priority to U.S. patent application Ser. No.62/198,503 filed Jul. 29, 2015, which is incorporated herein by reference in its entirety.

### FIELD OF THE DISCLOSURE

The disclosed embodiments generally relates to communication systems, and more particularly, to messaging systems for electronic devices.

### BACKGROUND

Creating a chat on traditional messaging systems (e.g., WhatsApp) leads to a private chat between users. A user must invite or be invited to join a group chat based on who the chat's participants believe are potentially interested in the subject matter of the chat. So, very rarely do people open group chats to discuss anything that's happening or they are paying attention at that specific moment(e.g., a TV broadcast, for instance). Also, certain social media systems allow for the creation and use of a content linking symbol (e.g., a hashtag on certain social media applications). However, while people do use such symbols to categorize and/or link content (e.g., with a tweet on Twitter or a Facebook post), users do not know if friends are receiving/monitoring that content as users cannot see any list of friends or other users participating on that topic. Users on such systems expect to share their messages with the world to only occasionally have their interested friends come across certain content or vice versa.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings. To achieve these and other advantages and in accordance with the purpose of the illustrated embodiments, in one aspect, a messaging system is described in which is configured to implement, via a suitable computerized device, a method for linking groups of users of a messaging system for a mobile computerized device.

The method includes receiving group chat data from a first user, said group chat data including one or more topics, to create an open messaging chat and displaying a list of other users that have joined the open messaging chat to the first user. The method can further include receiving messages from at least one of the other users in the list of other users.

The method can farther include comprising transmitting messages from the first user to one or more of the other users in the list of users. Transmitting can include sending messages to each other user individually. In certain embodiments, transmitting includes sending messages to at least two other users at the same time.

In accordance with at least one aspect of this disclosure, a server includes a memory, a processor disposed in communication with said memory, and configured to issue a plurality of instructions stored in the memory. The instructions can cause the processor to receive group chat data from a first user, said group chat data including one or more topics, to create an open messaging chat, allow other users to find and/or join the open messaging chat either manually and/or automatically based on other user profile information corresponding to the group chat data, and display a list of other users that have joined the open messaging chat to the first user or other users. The instructions can further cause the processor to receive and transmit messages between the first user and/or the other users.

In accordance with at least one aspect of this disclosure, a non-transitory computer readable storage medium can include one or more computer programs embedded therein, the one or more computer programs comprising instructions, which when executed by a computer system, cause the computer system to receive group chat data from a first user, said group chat data including one or more topics, to create an open messaging chat, and display a list of other users that have joined the open messaging chat to the first user.

The computer instructions can further include receiving messages from at least one of the other users in the list of other users. The computer instructions can further comprise transmitting messages from the first user to one or more of the other users in the list of users. Transmitting can include sending messages to each other user individually. Transmitting can include sending messages to at least two other users at the same time.

### BRIEF DESCRIPTION OF THE DRAWINGS

The accompanying appendices and/or drawings illustrate various non-limiting, example, aspects in accordance with the present disclosure:

FIG. 1 illustrates an example communication network in accordance with this disclosure;

FIG. 2 illustrates an example network device ode in accordance with this disclosure;

FIG. 3 illustrates a flow chart of an embodiment of a method in accordance with this disclosure; and

FIG. 4 illustrates an embodiment of a graphical user interface of a messaging system in accordance with this disclosure.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below can be a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

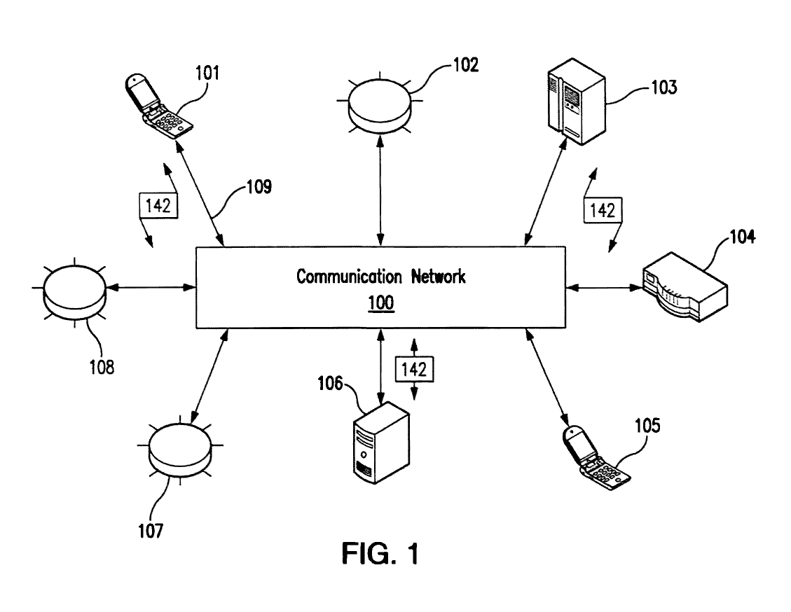

Turning now descriptively to the drawings, in which similar reference characters denote similar elements throughout the several views, FIG. 1 depicts an exemplary communications network 100 in which below illustrated embodiments may be implemented.

It is to be understood a communication network 100 can be a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of this disclosure may be embodied as a system method or computer program product. Accordingly, aspects of this disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure are described below with reference to flowchart illustrations and/or block diagrams of methods, apparatus (systems) and computer program products according to embodiments of disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

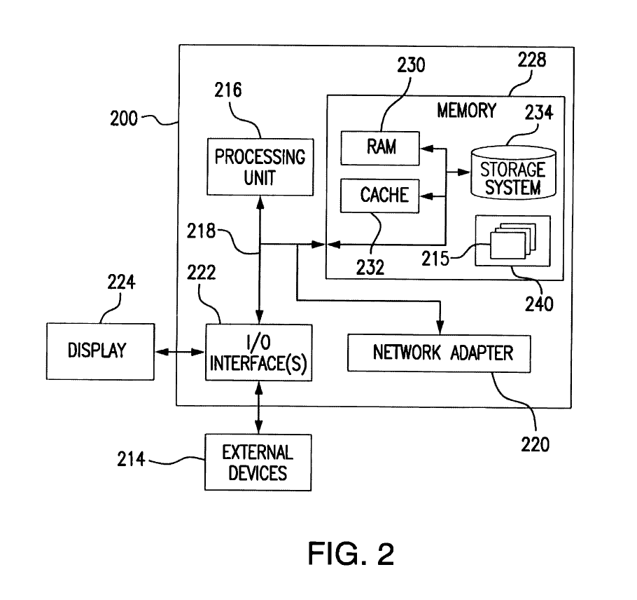

FIG. 2 is a schematic block diagram of an example network computing device 200 (e.g., client computing device 103, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various embodiments of this disclosure. Device 200 is only one example of a suitable system and is not intended to suggest any limitation as to the scope of use or functionality of embodiments of disclosure described herein. Regardless, computing device 200 is capable of being implemented and/or performing any of the functionality set forth herein.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing device 200 may be described in the general context of computer system executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

Device 200 is shown in FIG. 2 in the form of a general-purpose computing device. The components of device 200 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of disclosure.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of disclosure as described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which embodiments of this disclosure may be implemented. FIGS. 1 and 2 are exemplary of a suitable environment and are not intended to suggest any limitation as to the structure, scope of use, or functionality of an embodiment of this disclosure. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

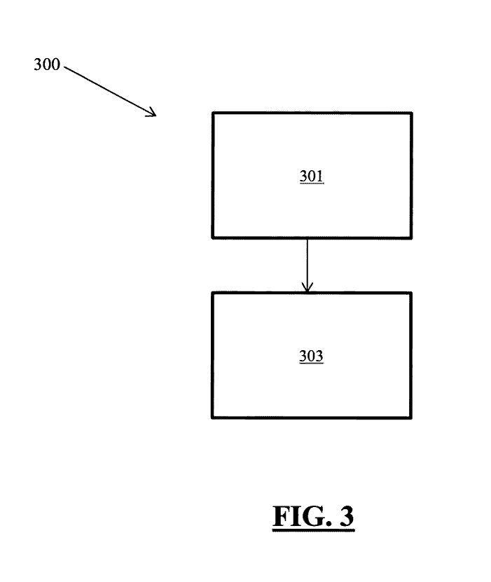

With the exemplary communication network 100 (FIG. 1) and computing device 200 (FIG. 2) being generally shown and discussed above, description of certain illustrated embodiments of this disclosure will now be provided. With reference now to FIG. 3, shown is a flow chart demonstrating implementation of the various exemplary embodiments. It is noted that the order of steps shown in FIG. 3 is not required, so in principle, the various steps may be performed out of the illustrated order. Also certain steps may be skipped, different steps may be added or substituted, or selected steps or groups of steps may be performed in a separate application following the embodiments described herein.

A messaging system is described that is configured to implement, via a suitable computerized device (e.g., a mobile device or any other suitable device), a method 300 for linking groups of users of a messaging system for a mobile computerized device.

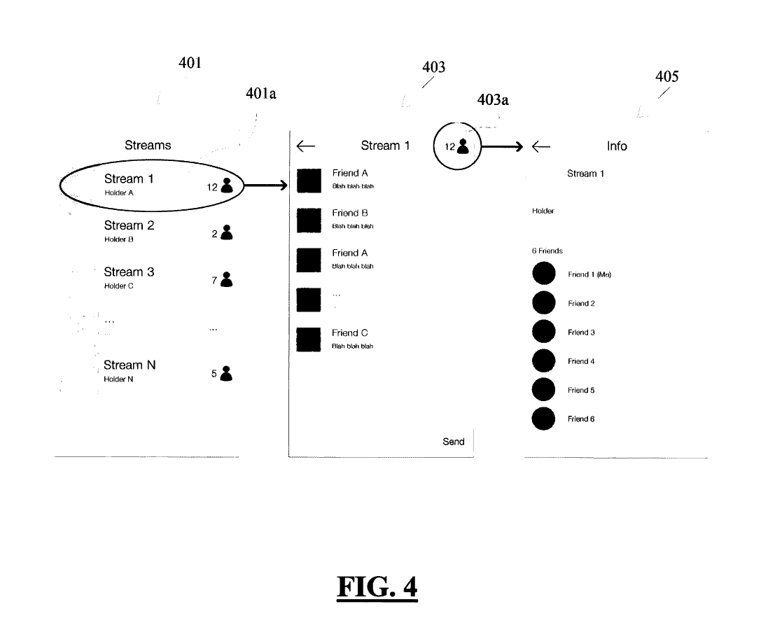

The method 300 includes receiving 301 group chat data from a first user (e.g., the creator of a chat, referred to as a “holder” in FIG. 4 described below). The group chat data can include one or more topics, to create an open messaging chat, and displaying 303 a list of other users that have joined the open messaging chat to the first user. The method 300 can further include receiving messages from at least one of the other users in the list of other users.

The method 300 can further include transmitting messages from the first user to one or more of the other users in the list of users. Transmitting can include sending messages to each other user individually such that the ⁻first user can have private conversations with each user that has joined the open messaging Chat. In certain embodiments, transmitting can include sending messages to at least two other users at the same time such that a group chat can be had between the first user and any suitable number of other users in the list.

It is also contemplated that the list of users can be displayed to other users(users that did not create the open messaging chat) and that the other users can message with each other privately or in a group as described above. Also, the list of users and/or the other users may be filtered to a group of friends (e.g., approved friends within the messaging system or a suitable social media platform) and/or known contacts (e.g., stored in a phonebook on the computerized device) that the each user is aware of such that users cannot see or message with people that are not in their group of friends or contacts, It is also contemplated that the open messaging chat may be truly public such that anyone with similar interests can join. However, any suitable degree of filtering (e.g., based on degrees of separation) to control which users can see certain groups and/or see/message with each other is contemplated herein.

Other users may be allowed to find and/or join the open messaging chat either manually (e.g., by searching for a topic) and/or automatically based on other user profile information corresponding to the group chat data. For example, in an automatic example, if a user has a user data (e.g., in the form of a profile) that indicates a particular interest (e.g., golf), the user can be presented with a list of friends that also share that interest and/or a list of friends discussing an event (e.g., a professional golf tournament) related to that interest and/or be placed into one or more such open messaging chats automatically.

It is understood by those skilled in the art that the term “message” can include any of alphanumeric text, images, video, audio, and/or any other suitable media. At least some portions of the methods and systems described herein can be implemented on any suitable mobile device in the form of a suitable software application (“app”).

For example, the method can include displaying a graphical user interface for use creating, finding, and/or joining groups, and/or messaging with users of a group. Referring to FIG. 4, embodiments of panes of a graphical user interface (GUI) are shown. The streams pane 401 can include a listing of one or more open messaging chats as described above (shown as “streams” 401a). Each stream can have a title (generically shown as “Stream 1”, “Stream 2”, etc.) which can include a topic, for example. Under the title, the creator of each stream 401a can be listed (Shown as “Holder A”, “Holder B”, etc.). Also, a total number of users (and/or just friends/contacts) who have joined the group can be listed on each stream 401a.

A user can select a stream (e.g., “Stream 1” as shown) to view a message pane 403 that can show a list of users e.g., “Friend A”, “Friend B”, etc.) that have sent a message in that stream. As shown, the messages can be organized chronologically or in any other suitable manner. Also as shown, the messages are directed to the entire group of users that have subscribed to that stream.

An info icon 403a can be displayed on the message pane 403 and allow the user to see how many users are participating in the stream. The info icon 403a can be selectable to bring the user to an info pane 405, The info pane 403a can provide information on the stream (e.g., all participants, who the creator of the group is (referred to as a “holder” of the stream as shown), the title of the group, information about the group or topic, or any other suitable information).

It is contemplated that at least some portions of the methods described herein can be implemented on a remote server or any other suitable computerized device as described above) that includes a memory, a processor disposed in communication with said memory, and configured to issue a plurality of instructions stored in the memory. The remote server can be accessible to the first user and the other users (e.g., via a suitable network such as the internet). The server can relay/send user lists to users to be displayed on the user's device. In certain embodiments, the server can also receive and transmit messages (e.g., as a relay, content filter, etc.) between the first user and/or the other users instead of direct device-to-device communication.

In accordance with at least one aspect of this disclosure, the methods and/or systems can be stored on any suitable non-transitory computer readable storage medium. For example a non-transitory computer readable storage medium can include one or more computer program embedded therein, the one or more computer programs comprising instructions, which when executed by a computer system, cause the computer system to receive group chat data from a first user, said group Chat data including one or more topics, to create an open messaging chat, and display a list of other users that have joined the open messaging chat to the first user. Any other suitable portions of a method are contemplated herein.

Utilizing embodiments of the above described methods and systems, users can find and freely enter any chat (stream) without previous invitation. In this respect, the streams can be entirely public, not private. Each user can know what friends are connected through the same chat and can share messages, photos, videos, and/or other suitable media.

Some advantages for media, celebrities, and companies include that users can promote their own businesses by creating chats (streams) and feeding them with content. Holders of streams can be treated like friends for everyone, so their messages will reach the whole audience of those Chats. Other users can be limited to reaching certain other users within the chat or can be allowed to reach everyone as well. Also, users can choose to sell digital content like stickers by building a store on their open messaging chats (e.g., streams).

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this disclosure, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

1. A computer-implemented method for linking groups of users of a messaging system for a mobile computerized device, said method comprising:
receiving group chat data from a first user, said group chat data including one or more topics, to create an open messaging chat; and
displaying a list of other users that have joined the open messaging chat to the first user.

2. The method of claim 1, further comprising receiving messages from at least one of the other users in the list of other users. The method of claim 1, further comprising transmitting messages from the first user to one or more of the other users in the list of users.

4. The method of claim 3, wherein transmitting includes sending messages to each other user individually.

5. The method of claim 3, wherein transmitting includes sending messages to at least two other users at the same time.

6. A server, comprising;
a memory;
a processor disposed in communication with said memory, and configured to issue a plurality of instructions stored in the memory, wherein the instructions cause the processor to:
receive group chat data from a first user, said group chat data including one or more topics, to create an open messaging chat;
allow other users to find and/or join the open messaging chat either manually and/or automatically based on other user profile information corresponding to the group chat data; and
display a list of other users that have joined the open messaging chat to the first user or other users.

7. The server of claim 6, wherein the instructions further cause the processor to receive and transmit messages between the first user and/or the other users.

8. A non-transitory computer readable storage medium and one or more computer programs embedded therein, the one or more computer programs comprising instructions, which when executed by a computer system, cause the computer system to:
receive group chat data from a first user, said group chat data including one or more topics, to create an open messaging chat; and display a list of other users that have joined the open messaging Chat to the first user.

9. The non-transitory computer readable medium of claim 8, wherein the co instructions further comprise receiving messages from at least one of the other users in the list of other users.

10. The non-transitory computer readable medium of claim 8, wherein the computer instructions further comprise transmitting messages from the first user to one or more of the other users in the list of users.

11. The non-transitory computer readable medium of claim 10, wherein transmitting includes sending messages to each other user individually.

12. The non-transitory computer readable medium of claim 10, wherein transmitting includes sending messages to at least two other users at the same time.
